(19) United States
(12) Patent Application Publication
(10) Pub. No.: US 2021/0323030 A1
(43) Pub. Date: Oct. 21, 2021

(54) SIEVE ACTUATION

(71) Applicant: HEWLETT-PACKARD DEVELOPMENT COMPANY, L.P., Spring, TX (US)

(72) Inventors: Mayid SHAWI SANCHEZ, Sant Cugat del Valles (ES); Peter James BOUCHER JR., Washington, WA (US); Marina FERRAN FARRES, Vancouver, WA (US)

(21) Appl. No.: 17/051,763

(22) PCT Filed: Oct. 30, 2018
(86) PCT No.: PCT/US2018/058091

§ 371 Date: Oct. 29, 2020

(51) Int. Cl. B07B 1/42; B29C 64/314; B33Y 40/10; B07B 1/30

(52) U.S. Cl. CPC B07B 1/42; B07B 1/30; B33Y 40/10; B29C 64/314

(57) ABSTRACT

Example implementations provide a control system to control a system for actuating a sieve, the system comprising an actuator mechanism to actuate the sieve to produce a sieving action to sieve a particulate within the sieve, and a sensor to determine an electrical characteristic associated with the actuator mechanism; the controller comprising circuitry to determine the amount of the particulate within the sieve in response to the determined electrical characteristic associated with the actuator mechanism.

### BACKGROUND

Some 3D printers use particulates as build materials. Such 3D printers may deposit a layer of particulates, treat the particulates with a printing liquid and use heat to fuse the particulates together. Excess particulates can be recovered to be used in another 3D build job. However, not all of the recovered particulates may be suitable to be used in another 3D build job, at least in part because some of the unused particulates may have become inadvertently fused together.

### BRIEF INTRODUCTION OF THE DRAWINGS

Examples implementations are described below with reference to the accompanying drawings, in which:

FIG. 1 shows a schematic diagram of system to sieve particulates according to some examples;

FIG. 2 illustrates another view of the sieve according to some examples;

FIG. 3 depicts a view of an E-shaped laminate (E-Lam) and an I-shaped laminate (I-Lam) according to some examples;

FIG. 4 shows a further of the E-Lam and the I-Lam according to some examples;

FIG. 5 illustrates a still further a view of the E-Lam and the I-La, according to some examples;

FIG. 6 shows a variation in an electrical characteristic associated with the actuation mechanism according to example implementations;

FIG. 7 depicts a flowchart according to some examples; and

FIG. 8 shows machine-readable storage and machine-executable instructions according to some examples.

### DETAILED DESCRIPTION

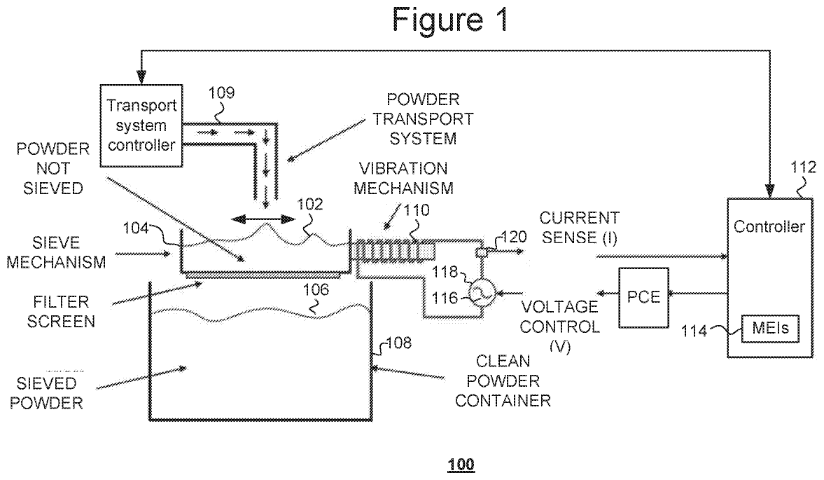

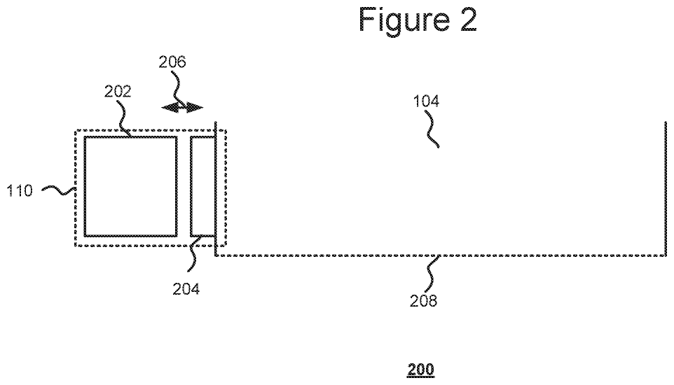

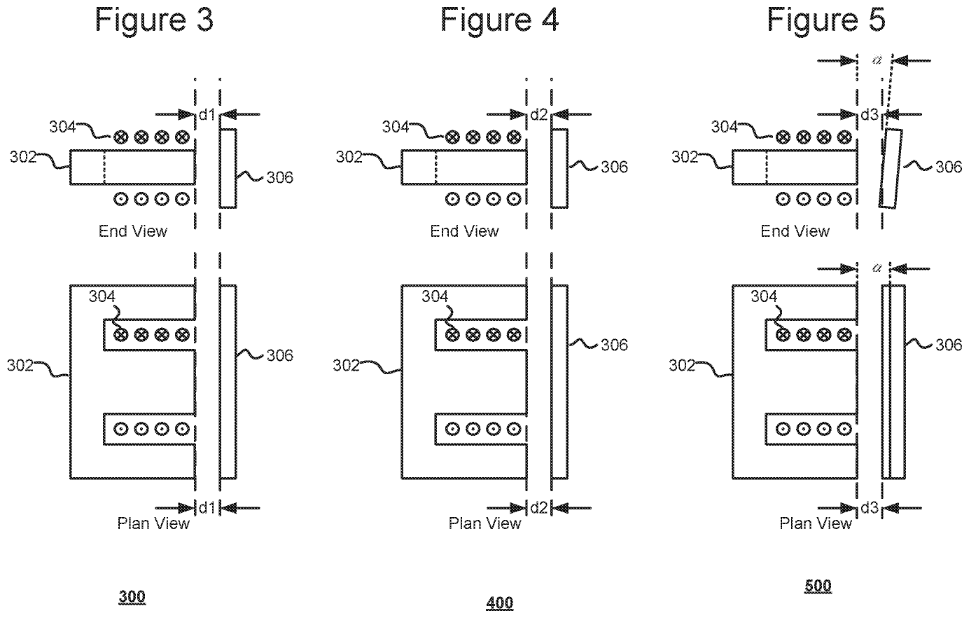

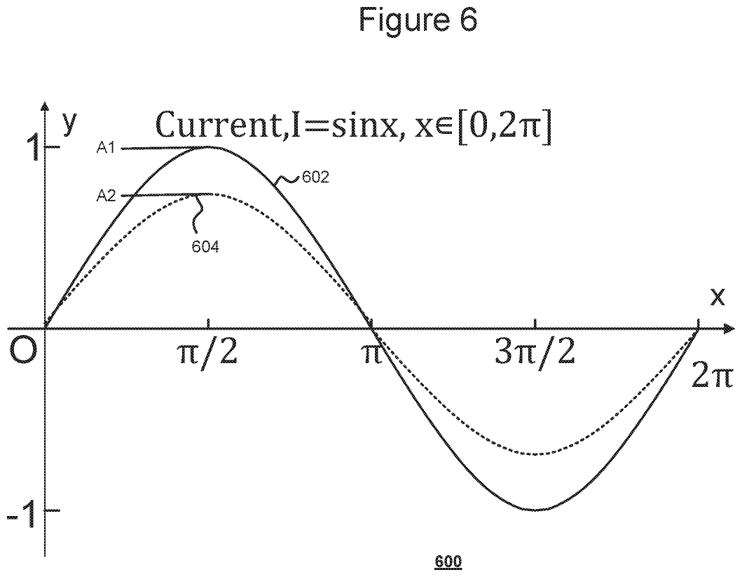

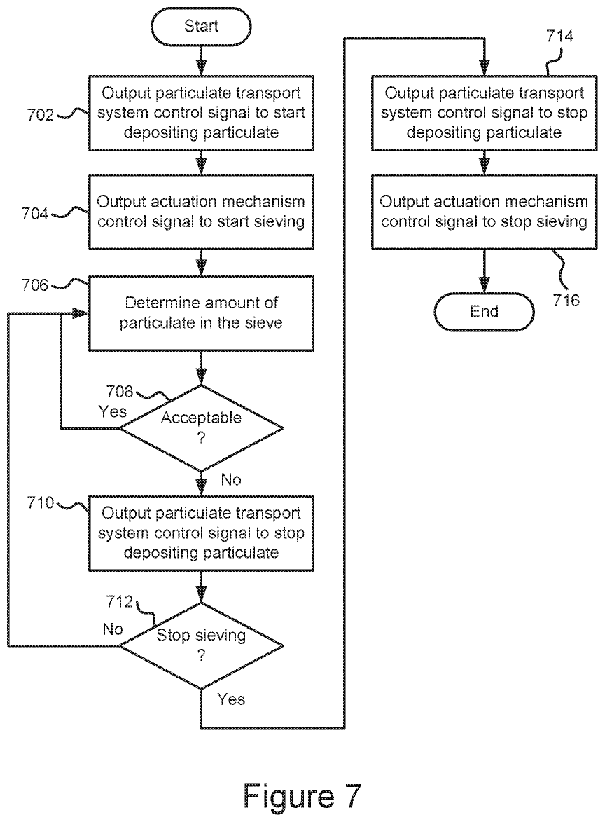

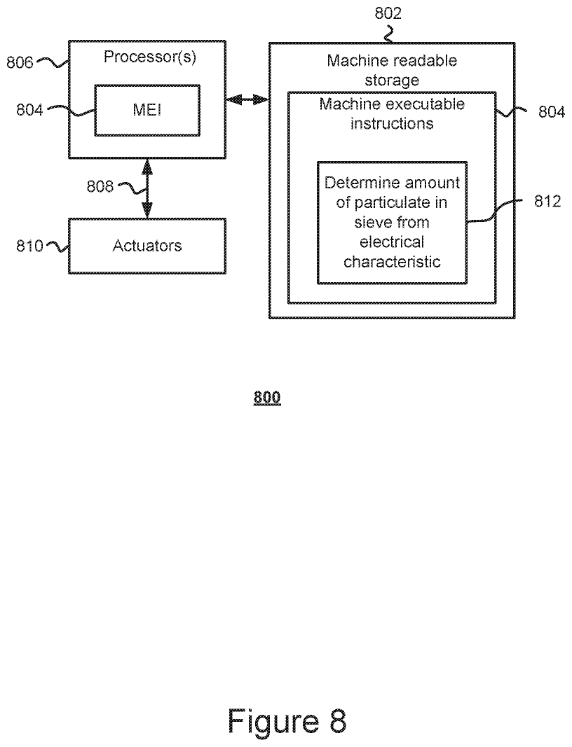

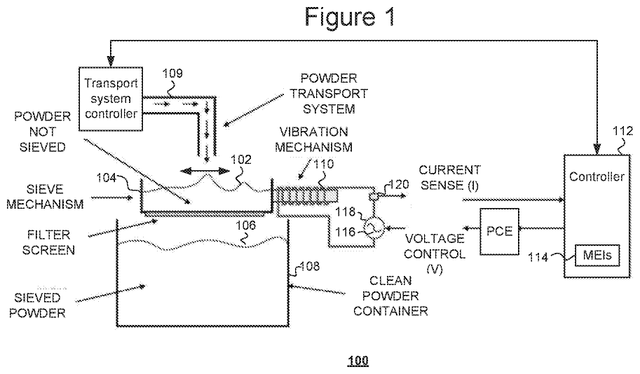

Referring to FIG. 1, there is shown a schematic view of a system 100 for sieving particulates 102. The system 100 comprises a sieve 104. The sieve 104, when actuated, produces sieved particulates 106. The sieved particulate 106 can be collected in a container 108. The particulates 102 can be delivered to the sieve 104 via a particulate transport system 109.

The container 108 can be a transport container for distributing or otherwise shipping the sieved particulates 106. The container can comprise a cardboard box. The cardboard box can be water-proof or at least water resistant.

The sieve 104 is actuated via an actuation mechanism 110. The actuation mechanism 110 is arranged to move the sieve 104 to induce a sieving action that sieves the particulates 102. The actuation mechanism 110 can comprise a vibration mechanism that causes the sieve 104 to move in a reciprocating manner, as shown by the double-headed arrow. Alternatively, the actuation mechanism 110 can comprise a vibration mechanism that causes the sieve 104 to move in some other manner such as, for example, in a circular manner, or other non-linear manner, to induce such a sieving action. The actuation mechanism 110 is an example of an electro-mechanical actuator.

The system 100 comprises a controller 112 for controlling the sieve 104. The controller 112 can comprise a processor suitably programmed to control the operation of the system 100. The controller 112 is an example of circuitry. The controller 112 can comprise machine-executable instructions (MEIs) 114 for controlling the operation of the system 100.

The controller 112 is operable to control a signal 116 applied to the actuation mechanism 110. The signal 116 can be applied to the actuation mechanism 110 using, for example, a voltage-controlled oscillator 118, or in any other way. The signal can have at least one, or both, of a predetermined amplitude or a predetermined frequency. The predetermined amplitude or predetermined frequency, or both, is arranged to cause the actuation mechanism 110 to sieve the particulates. The signal 118 can be a pulse width modulated (PWM) signal having at least one, or both, of such a predetermined amplitude or such a predetermined frequency, in addition to a predetermined or variable pulse width.

The system 100 comprises a sensor 120 for measuring at least one electrical characteristic associated with the actuation mechanism 110. The sensor 120 can be a current sensor for sensing a current drawn or used by the actuation mechanism 110 when subjected to the control signal 116.

The at least one electrical characteristic associated with the actuation mechanism 110 can vary according to an amount of particulate present in the sieve 104. Example implementations can be realised in which the current drawn or used by the actuation mechanism 110 varies according to the amount of particulate present in the sieve 104. Example implementations can be realised in which a characteristic of the current decreases as the amount of particulate in the sieve 104 increases and visa-versa. For example, the amplitude of the current drawn or used by the actuation mechanism 110 can decrease as the amount particulate within the sieve 104 increases and visa-versa.

Example implementations can be realised in which the actuation mechanism 110 comprises an inductance such as, for example, a mutual inductance, and in which a variation in the at least one electrical characteristic is associated with a change in the inductance associated with the actuation mechanism 110.

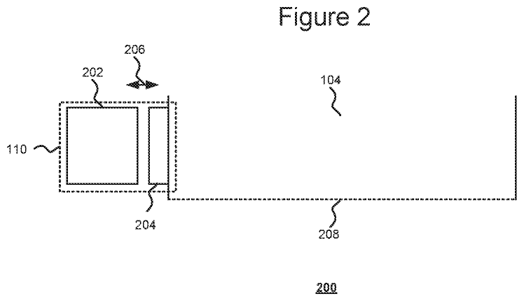

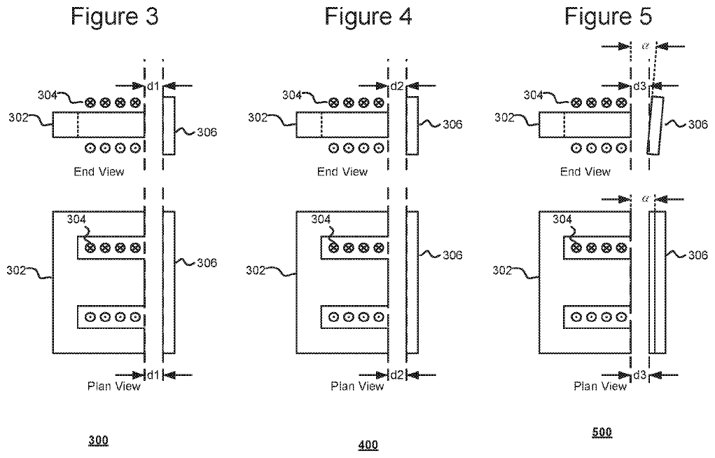

Referring to FIG. 2, there is shown a side view 200 of the actuation mechanism 110 and sieve 104. The actuation mechanism 110 comprises a first inductor 202 that is responsive to the control signal 116 for controlling the voltage-controlled oscillator 118. The first inductor 202 can comprise a conductive E-shaped laminate (E-Lam), as depicted in FIGS. 3 to 5, together with corresponding windings (not shown). The first inductor 202 has an associated conductive I-shaped laminate (I-Lam) 204. The E-shaped laminate 202 and the I-shaped laminate 204 are known as EI-Lams. It will be appreciated that the time varying control sign 116 will result in the E-Lam 202 and the I-Lam 204 being magnetically coupled, via mutual inductance, such that the I-Lam 204 oscillates about an equilibrium position. The oscillating I-Lam 204, in turn, causes the sieve 104 to oscillate, which produces a corresponding sieving action that sieves any particulates within the sieve 104. The oscillations are reciprocating movements in the directions of the arrows 206 shown.

It can be appreciated that the sieve 104 has a hole-bearing floor 206 that allows particulates below a predetermined size to pass through the floor and, conversely, prevents other particulates from doing so.

FIG. 3 shows plan and end views 300 of an E-I Lam comprising the E-Lam 302 bearing an inductor 304, or windings, and an I-Lam 306 that oscillates in response to the inductor 304 being excited by the control signal 116.

The E-I-Lam of FIG. 3 is an example of the above E-Lam 202 and I-Lam 204. The inductor 304 is an example of the above inductor 202.

It can be appreciated that the E-Lam 302 and the I-Lam 306 are separated by a predetermined distance, d1, in an equilibrium state, that is, in a state where the sieve 104 is not loaded with particulates. The predetermined distance, d1, creates, in use, an associated mutual inductance between the inductor 304 and the I-Lam 306. The mutual inductance gives rise to an associated current in response to the control signal 116. A change in the mutual inductance produces an associated change in the current drawn or used by the actuation mechanism 110 in response to the control signal 116.

FIG. 4 shows plan and end views 400 of the E-I Lam comprising the E-Lam 302 bearing the inductor 304, or windings, and the I-Lam 306 that oscillates in response to the inductor 304 being excited by the control signal 116. It can be appreciated that the E-Lam 302 and the I-Lam 306 are separated by a different predetermined distance, d2. The different predetermined distance arises due to the sieve 104 being loaded with particulates.

In the example implementation shown, d2>d1. The increased separation between the inductor 304 and the I-Lam 306 produces a different actuator mechanism system response to the control signal 116. The predetermined distance, d2, creates an associated, different, mutual inductance between the inductor 304 and the I-Lam 306. The mutual inductance gives rise to a respective associated current in response to the control signal 116. The change in the mutual inductance produces a respective associated change in the current drawn or used by the actuation mechanism 110 in response to the control signal 116.

Example implementations can be realised in which the mutual inductance is reduced when the sieve is loaded, which manifests itself as a reduction in the current drawn or used by the actuation mechanism 110 in response to the control signal. The change in current drawn or used by the actuation mechanism 110 in response to the control signal 116 can be correlated with different amounts, or weights, of the particulate in the sieve 104 at any given instant in time.

FIG. 5 shows plan and end views 500 of the E-I Lam comprising the E-Lam 302 bearing the inductor 304, or windings, and the I-Lam 306 that oscillates in response to the inductor 304 being excited by the control signal 116. It can be appreciated that the E-Lam 302 and the I-Lam 306 are separated by a different predetermined average distance, d3. The different average predetermined distance arises due to the sieve 104 being loaded with particulates. In the example implementation shown, d3>d1.

However, it can also be appreciated that there is an increased separation between the inductor 304 and the I-lam 306 due to a change in relative or orientation inclination between the E-Lam 302 and the I-Lam 306. In the example implementation shown, the relative inclination or orientation has changed from being parallel in FIG. 3, which corresponds to the sieve 104 being unloaded, to inclined at an angle, α, which corresponds to the sieve 104 being loaded. Relative inclination or orientation are examples of a relative position. The increased separation between the inductor 304 and the I-Lam 306, due to the sieve being loaded, produces a further different actuator mechanism system response to the control signal 116. At least one, or both, of the angle of inclination and the predetermined distance, d3, creates an associated, different, mutual inductance between the inductor 304 and the I-Lam 306. The mutual inductance gives rise to a respective associated current in response to the control signal 116. The change in the mutual inductance produces a respective associated change in the current drawn or used by the actuation mechanism 110 in response to the control signal 116.

Example implementations can be realised in which the mutual inductance is reduced when the sieve is loaded, which manifests itself as a reduction in the current drawn or used by the actuation mechanism 110 in response to the control signal. The change in current drawn or used by the actuation mechanism 110 in response to the control signal 116 can be correlated with different amounts, or weights, of the particulate in the sieve 104 at any given instant in time. In any example implementation or in any of the claims the electrical characteristic associated with the actuator mechanism can comprise, or can be, a mutual inductance associated with the actuator mechanism, the mutual inductance varying with the variation of particulate within the sieve.

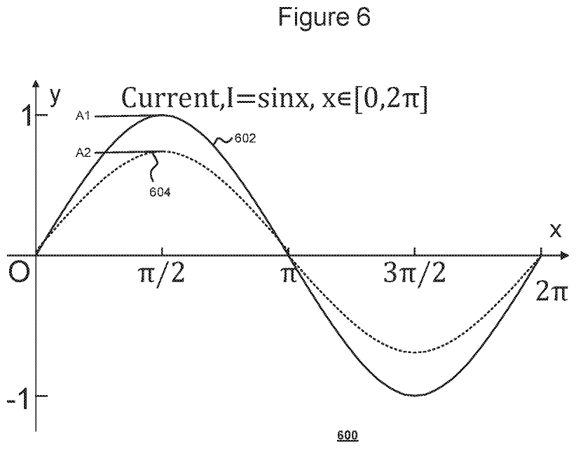

FIG. 6 shows a schematic view 600 of the variation in an electrical characteristic associated with the actuation mechanism 110 in response to the sieve 104 being loaded relative to an unloaded state. In the example depicted, the electrical characteristic is current drawn or used by the actuation mechanism 110 in response to the control signal 116. A first curve 602 represents the variation in current drawn or used by the actuation mechanism 110 when actuating an unloaded sieve. The current has a predetermined amplitude, A1, that has been normalised to “1”. The sieve 104 is moved at a predetermined frequency. The predetermined frequency can be, for example a frequency from a predetermined range of frequencies. Such a predetermined range of frequencies can comprise 12 Hz to 23 Hz. Example implementations can be realised that use 13 Hz, or some other suitable frequency for sieving the particulates. In operation, when the sieve 104 is loaded with particulates, the current drawn or used by the actuation mechanism 110 has a reduced amplitude, A2. The reduced amplitude current, A2, is correlated or otherwise related to the amount of particulate in the sieve 104. The reduced current amplitude can arise due to the above described change in the mutual inductance.

The controller 112 can use the reduced amplitude current to control the flow of particulates 102 into the sieve 104 via the particulate transport system 109 via the respective particulate transport system control signal 122. The control signal 122 is used to start and stop, or otherwise regulate, the flow of particulates into the sieve 104.

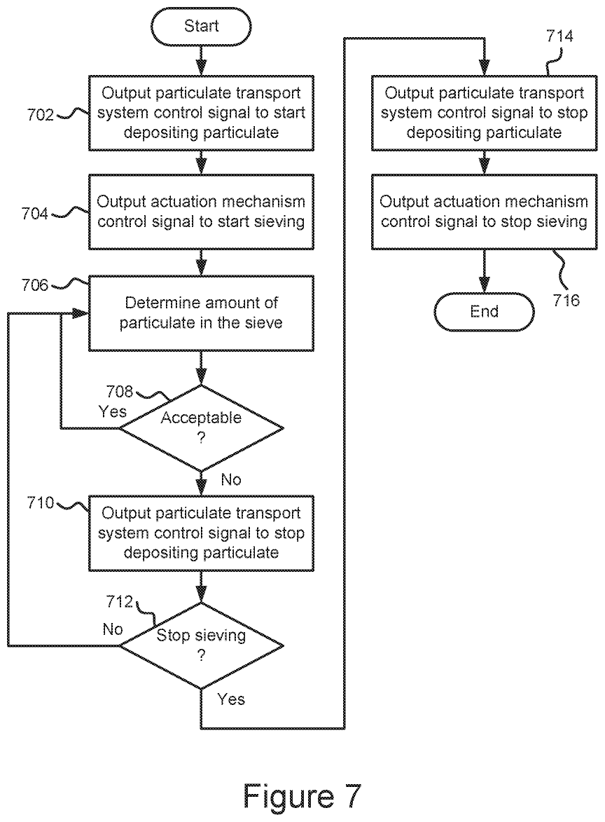

Referring to FIG. 7, there is shown a view 700 of a flow chart according to example implementations. At 702, the controller 112 outputs a control signal, such as the above described control signal 122, to control the particulate transport system 109 to deposit particulates into the sieve 104.

At 704, concurrently, or before or after, the particulate transport system 109 starts depositing particulates 102 into the sieve 104, the controller 112 outputs a control signal, such as the above described control signal 116, to drive the actuation mechanism 110 to move the sieve 104 so that the particulates 102 can be sieved.

At 706, a determination is made regarding the amount of particulates in the sieve 104. The determination is realised by measuring the current used or drawn by the actuation mechanism 110 as the sieve 104 becomes progressively more loaded.

If it is determined at 708 that the weight of the particulates within the sieve 104 has a predetermined relationship with a respective threshold, processing returns to 706. Example implementations can be realised in which it is determined at 708 that the weight of the particulates within the sieve 104 is at or below a predetermined threshold such that processing returns to 706. If it is determined at 708 that the weight of the particulates within the sieve 704 has a different predetermined relationship with the respective threshold, the controller 112 outputs a particulate transport control signal 122 at 710 to stop transporting particulates to the sieve 104, or to at least vary such as, for example, reduce, the rate of transfer of the particulates to the sieve 104. Example implementations can be realised in which it is determined at 708 that the weight of the particulates within the sieve 104 is above the predetermined threshold such that the controller 112 outputs the particulate transport control signal 122 at 710 to stop transporting particulates to the sieve 104, or to at least vary, such as, for example, reduce, the rate of transfer of the particulates to the sieve 104.

A determination is made at 712 regarding whether or not the sieving process should be stopped. For example, the sieving process could be stopped if it is determined that the supply of unsieved particulates from the transport system 109 is exhausted or has a predetermined relationship with a respective threshold. An example of determining that the supply of unsieved particulates from the transport system 109 having such a predetermined relationship with a respective threshold can comprise determining that the particulate flow rate has dropped below a particular particulate flow rate threshold. Example implementations can be realised in which the sieving process is stopped if it is determined that the particulate flow rate has dropped to zero. If it is determined at 712 that the sieving process should be stopped, the controller 112 outputs a particulate transport system control signal 122 to stop transporting particulates to the sieve 104 and the controller 112 outputs a control signal 116 to the actuation mechanism 110 to stop sieving. However, if the determination at 712 is that the sieving process should continue, then control returns to 706.

The determination at 706 relating to the weight of particulates or the amount of particulates within the sieve 104 can use the above described change in the at least one electrical characteristic associated with the actuation mechanism 110 to calculate or otherwise assess how much particulate is in the sieve 104.

The particulate can comprise, for example, a build material. The build material can be a build material for a 3D printer. Examples of one or more build materials can comprise at least one of a polymer, or other plastic, a metal powder, a ceramic powder or other powder-like material, or lengths build material, taken jointly and severally in any and all permutations. The lengths of build material can comprise fibres or threads of build material. The fibres of threads of build material can be formed from, or otherwise derived from, longer or large units of build material. The build material can be responsive to heat, or a binding agent, to fuse, or bind, adjacent particles of build material. For example, the build material to be fused can be defined with a printing fluid. The printing fluid can be arranged to couple heat to the build material to cause adjacent build material to fuse together. Additionally, or alternatively, the printing fluid may cause chemical binding of the build material. Furthermore, the chemically bound build material can be subject to heat to fuse the build material together. Examples implementations can be realised in which the build material is spent build material. Spent build material can comprise build material that was distributed as part of a 3D build job but that did not form part of the resulting 3D product resulting from that 3D build job. Such spent build material can be used in another 3D build job, that is, it can be recycled. Such spent build material can contain fused build material. The fused build material can be unsuitable for re-use in another 3D build job and is, therefore, prevented from forming part of any recycled build material. The sieve 104 is used to separate particulates that are suitable for recycling from particulates that are unsuitable for recycling, especially those particulates for which additional processing would be beneficial beyond sieving such as, for example, the fused particulates that could be reformed as powder.

Example implementations can be realised in the form of machine-executable instructions arranged, when executed by a machine, to implement any or all aspects, processes, activities or flowcharts, taken jointly and severally in any and all permutations, described in this application. Therefore, implementations also provide machine-readable storage storing such machine-executable instructions. The machine-readable storage can comprise non-transitory machine-readable storage. The machine can comprise one or more processors or other circuitry for executing the instructions or implementing the instructions. For example, the controller 112 can process any such machine-executable instructions.

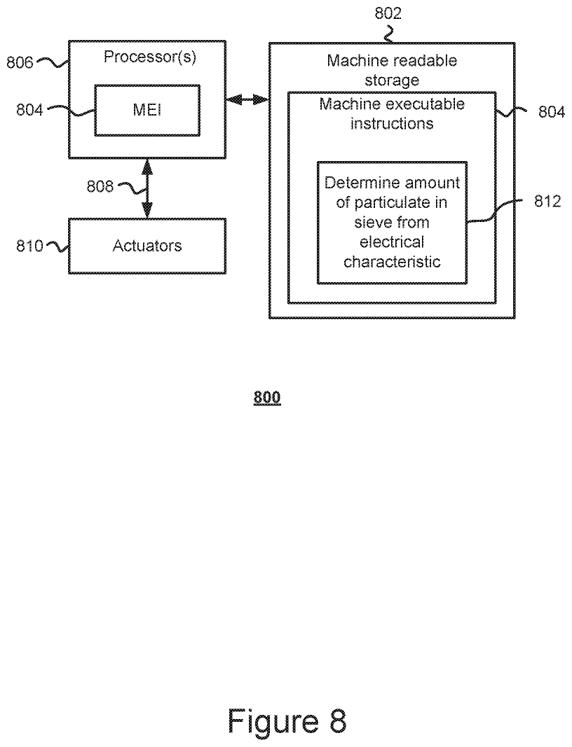

Referring to FIG. 8, there is shown a view 800 of implementations of at least one of machine-executable instructions or machine-readable storage. FIG. 8 shows machine-readable storage 802. The machine-readable storage 802 can be realised using any type of volatile or non-volatile storage such as, for example, memory, a ROM, RAM, EEPROM, optical storage and the like. The machine-readable storage 802 can be transitory or non-transitory. The machine-readable storage 802 stores machine-executable instructions (MEIs) 804. The MEIs 804 comprise instructions that are executable by a processor or other instruction execution or instruction implementation circuitry 806. The processor or other circuitry 806 is responsive to executing or implementing the MEIs 804 to perform any and all activities, operations, methods described and claimed in this application.

The processor or other circuitry 806 can output control signals 808 for influencing the operation of one or more than one actuator 810 for performing any and all operations, activities or methods described and claimed in this application. The actuators 810 can comprise at least one, or both, of the above described actuation mechanism 110 and the particulate transport system 109 and the control signals 808 can implement or are example of the above control signals 116 and 112.

The controller 112 can be an implementation of the foregoing processor or other circuitry 806 for executing any such MEIs 804.

The MEIs 804 can comprise MEIs to implement the flow chart of FIG. 7 or any part thereof taking jointly and severally with any other part thereof.

Example implementations can be realised according to the following clauses:

Clause 1: A control system for actuating a sieve, the system comprising an actuator mechanism to actuate the sieve to produce a sieving action to sieve a particulate within the sieve, and a sensor to determine an electrical characteristic associated with the actuator mechanism; the controller comprising circuitry to determine the amount of the particulate within the sieve in response to the determined electrical characteristic associated with the actuator mechanism.

Clause 2: The control system of clause 1, in which the actuator mechanism comprises at least one inductor and an associated movable member; the inductor and the movable member being, in use, magnetically coupled, wherein the inductor is responsive to a respective control signal to move the member to produce the sieving action.

Clause 3: The control system of clause 2, in which the relative position of the inductor and the movable member can vary in response to the amount of the particulate within the sieve.

Clause 4: The control system of either of clauses 2 and 3, in which the circuitry to determine the amount of the particulate within the sieve comprises circuitry to determine an electrical characteristic of a current drawn or used by the actuation mechanism; the electrical characteristics of the current drawn or used by the actuation mechanism being associated with the amount of particulate within the sieve.

Clause 5: The control system of clause 4, comprising in which the sensor comprises a current sensor to determine the current drawn or used by the actuation mechanism.

Clause 6: The control system of either of clauses 4 and 5, in which the electrical characteristic comprises a time varying current and in which the circuitry to determine the amount of the particulate within the sieve in response to the electrical characteristic comprises circuitry to determine an amplitude of the time varying current; the amplitude being associated with a current amount of particulate within the sieve.

Clause 7: The control system of any of clauses 1 to 6, in which the electrical characteristic associated with the actuator mechanism comprises a mutual inductance associated with the actuator mechanism, the mutual inductance varying with the variation of particulate within the sieve.

Clause 8: A system to sieve a build material for a 3D printer, the system comprising

an electro-mechanical actuator for moving a sieve for containing the build material in response to an electrical signal; the electro-mechanical actuator comprising at least one inductor responsive to the electrical signal to move the sieve, wherein loading the sieve with build material causes, in use, an associated change in mutual inductance associated with the electro-mechanical actuator; and

circuitry to determine the amount of build material within the sieve from an electrical characteristic of the electro-mechanical actuator associated with the change in mutual inductance.

Clause 9: A controller for a sieve for sieving a build material; the controller comprising an output interface to output a control signal associated with controlling an actuation mechanism to move the sieve, an input interface to receive an input signal associated with an electrical characteristic of the actuation mechanism; the electrical characteristic varying according to an amount of build material within the sieve; and circuitry to determine the amount of build material within the sieve from the electrical characteristic associated with the actuation mechanism.

Clause 10: The controller of clause 9, further comprising circuitry to control a build material transport system for transporting build material to the sieve in response to the determined amount of build material within the sieve.

Clause 11: Machine-readable storage storing instructions, arranged when executed, to control a system to actuate a sieve, the instructions comprising: instructions to actuate, via an actuation mechanism, a sieve to produce a sieving action to sieve a particulate within the sieve in response; instructions to control the flow of the particulate into the sieve in response to a determined electrical characteristic associated with the actuation mechanism.

Clause 12: Machine-readable storage of clause 11, storing instructions to output a respective control signal to the actuator mechanism that comprises at least one inductor and an associated movable member; the inductor and the movable member being, in use, magnetically coupled with the inductor, to move the movable member to produce the sieving action.

Clause 13: Machine-readable storage of clause 12, storing instructions to determine an electrical characteristic of a current drawn or used by the actuation mechanism; the electrical characteristic of the current drawn or used by the actuation mechanism being associated with the amount of particulate within the sieve.

Clause 14: Machine-readable storage of clause 13, storing instructions to control reading a current sensor to determine the current drawn or used by the actuation mechanism.

Clause 15: Machine-readable storage of either of clauses 13 and 14, in which the electrical characteristic comprises a time varying current and in which the circuitry to determine the amount of the particulate within the sieve in response to the electrical characteristic comprises instructions to determine an amplitude of the time varying current; the amplitude being associated with the present amount of particulate within the sieve.

What is claimed is:

1. A control system for actuating a sieve, the system comprising an actuator mechanism to actuate the sieve to produce a sieving action to sieve a particulate within the sieve, and a sensor to determine an electrical characteristic associated with the actuator mechanism; the controller comprising circuitry to determine the amount of the particulate within the sieve in response to the determined electrical characteristic associated with the actuator mechanism.

2. The control system of claim 1, in which the actuator mechanism comprises at least one inductor and an associated movable member; the inductor and the movable member being, in use, magnetically coupled, wherein the inductor is responsive to a respective control signal to move the member to produce the sieving action.

3. The control system of claim 2, in which the relative position of the inductor and the movable member can vary in response to the amount of the particulate within the sieve.

4. The control system of claim 2, in which the circuitry to determine the amount of the particulate within the sieve comprises circuitry to determine an electrical characteristic of a current drawn or used by the actuation mechanism; the electrical characteristics of the current drawn or used by the actuation mechanism being associated with the amount of particulate within the sieve.

5. The control system of claim 4, comprising in which the sensor comprises a current sensor to determine the current drawn or used by the actuation mechanism.

6. The control system of claim 4, in which the electrical characteristic comprises a time varying current and in which the circuitry to determine the amount of the particulate within the sieve in response to the electrical characteristic comprises circuitry to determine an amplitude of the time varying current; the amplitude being associated with a current amount of particulate within the sieve.

7. The control system of claim 1, in which the electrical characteristic associated with the actuator mechanism comprises a mutual inductance associated with the actuator mechanism, the mutual inductance varying with the variation of particulate within the sieve.

8. A system to sieve a build material for a 3D printer, the system comprising
an electro-mechanical actuator for moving a sieve for containing the build material in response to an electrical signal; the electro-mechanical actuator comprising at least one inductor responsive to the electrical signal to move the sieve, wherein loading the sieve with build material causes, in use, an associated change in mutual inductance associated with the electro-mechanical actuator; and
circuitry to determine the amount of build material within the sieve from an electrical characteristic of the electro-mechanical actuator associated with the change in mutual inductance.

9. Machine-readable storage storing instructions, arranged when executed, to control a system to actuate a sieve, the instructions comprising:
instructions to actuate, via an actuation mechanism, a sieve to produce a sieving action to sieve a particulate within the sieve in response; and
instructions to control the flow of the particulate into the sieve in response to a determined electrical characteristic associated with the actuation mechanism.

10. Machine-readable storage of claim 9, storing instructions to output a respective control signal to the actuation mechanism to influence the operation of the actuation mechanism; the actuation mechanism comprising at least one inductor and an associated movable member; the inductor and the movable member being, in use, magnetically coupled with the inductor, to move the movable member to produce the sieving action.

11. Machine-readable storage of claim 10, storing instructions to determine an electrical characteristic of a current drawn or used by the actuation mechanism; the electrical characteristic of the current drawn or used by the actuation mechanism being associated with the amount of particulate within the sieve.

12. Machine-readable storage of claim 11, storing instructions to control reading a current sensor to determine the current drawn or used by the actuation mechanism.

13. Machine-readable storage of claim 11, in which the electrical characteristic comprises a time varying current and in which the instructions to determine the amount of the particulate within the sieve in response to the electrical characteristic comprises instructions to determine an amplitude of the time varying current; the amplitude being associated with the present amount of particulate within the sieve.
